(19) United States
(12) Patent Application Publication
(10) Pub. No.: US 2025/0092545 A1
(43) Pub. Date: Mar. 20, 2025

(54) PLASMONIC SUBSTRATE FOR PLASMONIC ENHANCEMENT

(71) Applicant: SAUDI ARABIAN OIL COMPANY, Dhahran (SA)

(72) Inventor: Shiv Shankar Sangaru, Khobar (SA)

(73) Assignee: SAUDI ARABIAN OIL COMPANY, Dhahran (SA)

(21) Appl. No.: 18/471,100

(22) Filed: Sep. 20, 2023

(51) Int. Cl. C25B 11/087; C25B 1/04; C25B 1/55; C25B 11/054; C25B 11/055

(52) U.S. Cl. CPC C25B 11/087; C25B 1/04; C25B 1/55; C25B 11/054; C25B 11/055

(57) ABSTRACT

A plasmonic substrate includes a base, a metallic film on the base, and a semiconducting photocatalyst on the metallic film. A method for producing a plasmonic substrate includes depositing a first metal layer having a thickness ranging from 10 to 200 nm and having a first metal through a physical vapor deposition technique onto a base, depositing a second metal layer having a second metal through a physical vapor deposition technique onto the first metal layer forming a multilayered metal template, immersing the multilayered metal template into a solution having a salt or complex of the second metal for a period of time forming a metallic film, and depositing a semiconducting photocatalyst on the metallic film. A method of catalyzing hydrogen production includes immersing a plasmonic substrate in a photocatalytic solution, exposing the plasmonic substrate to light, and generating hydrogen at a surface of the semiconducting photocatalyst.

### BACKGROUND

The importance of hydrogen as an energy source is well known and therefore technological developments in environmentally friendly hydrogen production are important for hydrogen implementation as a fuel source. The photocatalytic process offers one such pathway that utilizes sunlight and water to directly produce hydrogen through the water splitting reaction utilizing a photocatalyst. Furthermore, it is considered a low carbon footprint process for hydrogen production compared to other methods such as steam methane reforming and electrocatalytic water splitting. Additionally, the system design is simpler and has potential for scale-up. However, the reported efficiencies of photocatalysts are relatively low. Accordingly, there exists a need for materials achieving improved efficiencies for photocatalysis and related processes.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a plasmonic substrate which includes a base, a metallic film on the base and a semiconducting photocatalyst on the metallic film. The metallic film has an RMS roughness measured by atomic force microscopy ranging from 10 to 200 nm.

In another aspect, embodiments disclosed herein relate to a method for producing a plasmonic substrate, which includes depositing a first metal layer having a thickness ranging from 10 to 200 nm comprising a first metal through a physical vapor deposition technique onto a base, depositing a second metal layer having a thickness ranging from 1 to 10 nm and comprising a second metal through a physical vapor deposition technique onto the first metal layer, thereby forming a multilayered metal template, immersing the multilayered metal template into a solution having a salt or complex of the second metal for a period of time thereby forming a metallic film, and depositing a semiconducting photocatalyst on the metallic film.

In yet another aspect, embodiments disclosed herein relate a method of catalyzing hydrogen production, which includes immersing a plasmonic substrate in a photocatalytic solution, exposing the plasmonic substrate to light, and generating hydrogen at a surface of the semiconducting photocatalyst. The plasmonic substrate includes a base, a metallic film on the base, and a semiconducting photocatalyst on the metallic film. The metallic film has an RMS roughness measured by atomic force microscopy ranging from 10 to 200 nm.

Other aspects and advantages of the claimed subject matter will be apparent from the following description and the appended claims.

### BRIEF DESCRIPTION OF DRAWINGS

FIG. 1 illustrates a plasmonic substrate in accordance with one or more embodiments of the present disclosure.

FIG. 2 illustrates the steps for fabricating a plasmonic substrate in accordance with one or more embodiments of the present disclosure.

FIG. 3 is a flow diagram of a method of photocatalytic hydrogen production in accordance with one or more embodiments of the present disclosure.

### DETAILED DESCRIPTION

Hydrogen production in photocatalytic processes is dependent on the rate of electron and hole pairs that are created in a photocatalyst due to the excitation energy received from the incident sunlight. Rough nanostructured metal surfaces may impart electromagnetic field enhancements and injection of hot electrons, thereby increasing hydrogen production in photocatalytic processes. The present disclosure relates to a photocatalytic substrate having a nanostructured surface morphology and a fabrication method to make said substrate. The substrate may advantageously enhance hydrogen production utilizing the plasmonic effect.

However, experimentally fabricating a substrate with uniform roughness at the nanoscale level in a reproducible manner is challenging. On such rough metal substrates, the electromagnetic field enhancements are usually observed solely at random hotspots throughout the surface because of their inhomogeneity. As a result, although the enhancement is high at specific locations the overall enhancement throughout the substrate surface still remains low. The present disclosure addresses the challenge of fabricating a substrate with uniform roughness at the nanoscale level, while providing a means to combine nanorough metallic substrates exhibiting uniform electromagnetic field enhancement with a photocatalyst material to achieve a higher rate of photocatalytic generation of hydrogen.

### Plasmonic Substrate

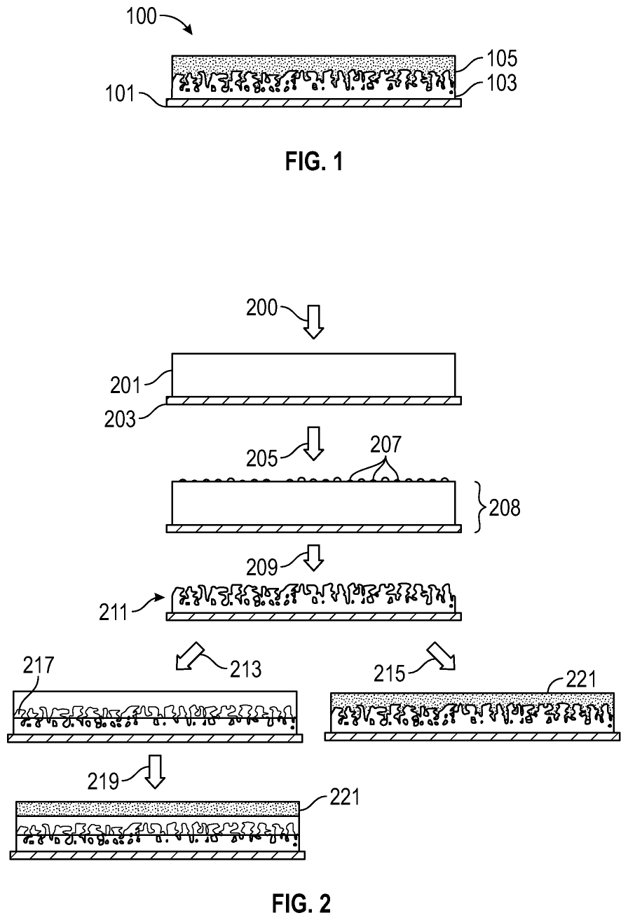

In one aspect, embodiments disclosed herein relate to a plasmonic substrate that may be used to provide electromagnetic field enhancement in photocatalysis and similar processes. FIG. 1 illustrates a plasmonic substrate in accordance with one or more embodiments of the present disclosure. The plasmonic substrate 100 comprises a base 101, a metallic film 103 with nanostructured roughness on the base 101, and a semiconducting photocatalyst 105 on the metallic film 103.

The base 101 serves as the platform for the deposition of subsequent layers, providing the initial surface and physical integrity for metal layer deposition. The base may be made of any suitable material to provide a substrate for deposition as described below. In one or more embodiments, a transparent substrate may be used as the base to facilitate plasmonic excitation with incident light from both above and below the substrate. However, in other embodiments, non-transparent substrates may be used with incident light being employed from a single side. In one or more embodiments, the base 101 material is selected from the group consisting of glass, quartz, silicon, doped silicon, and indium tin oxide. Suitable bases may be obtained commercially.

To improve the adhesion of metal layers to the base, the base may be coated with a layer of chromium oxide or it may be chemically modified with molecules such as 3-aminopropyl triethoxysilane or similar alkoxy silanes.

Referring back to FIG. 1, the plasmonic substrate includes a metallic film 103 on the base 101. In one or more embodiments, the metallic film 103 on the base 101 exhibits nanoscale roughness that is uniform over the area of the metallic film 103. The uniformity of the roughness may be quantified using atomic force microscopy (AFM) to measure the root mean square (RMS) roughness. The RMS roughness is the root mean square average of profile height deviations from the mean line, represented by the equation:

$${R}_{q} = \sqrt{\frac{1}{L} {\int }_{0}^{L} \vert {Z}^{2} ( x ) \vert dx}$$

where Rq is the root mean square average, L is the evaluation length, Z²(X) is the function that describes the square of the surface profile analyzed in terms of height (Z) and position (x).

As used herein, “uniform nanoscale roughness” means that the RMS roughness for the metallic film 103 is in an amount ranging from a lower limit of any of 10, 11, 12, 13, 14, 15, 16, 17, 18, 19, 20, 25, 30, 35, 40, 50 60, 75, and 100 nm to an upper limit of any of 120, 140, 150, 160, 170, 180, 190, and 200 nm, where any lower limit can be used in combination with any mathematically compatible upper limit. Consequently, the electromagnetic field enhancement does not vary significantly or display areas of greatly increased electromagnetic field enhancement or hotspots across the metallic film 103 because of the uniform nanoscale roughness. Exhibiting nanoscale roughness that is uniform over the area of the metallic film 103 allows the metallic film 103 to provide uniform electromagnetic field enhancement over the area of the metallic film 103.

While the thickness of metallic film 103 varies due to the roughness of the surface of metallic film 103, the average thickness may be an amount ranging from a lower limit of any of 10, 11, 12, 13, 14, 15, 16, 17, 18, 19, and 20 nm to an upper limit of any of 30, 35, 40, 45, and 50 nm, where any lower limit can be used in combination with any mathematically compatible upper limit. As noted above, roughness (and in particular RMS roughness) may be measured using AFM.

The morphology and concentration gradient of metals in the metallic film is variable, with the morphology formed during a variable solution metal deposition process which may involve Galvanic rearrangement of metal atoms in preceding structures. In one or more embodiments, the metallic film 103 is composed of a metal selected from the group consisting of silver, copper, gold and aluminum. More than one of the aforementioned metals may be present in the metallic film 103. There may be a layer of metal underneath the nanostructured outer layer. As will be explained in greater detail below, the extent of the Galvanic rearrangement of metal atoms will determine the final structure and if there is any metal underneath the nanostructured layer. A typical structure includes a certain thickness of a first metal present under a nanostructured second metal layer. Some of the first metal layer may be exposed. Even after complete Galvanic displacement reaction the second metal will likely contain trace amounts of the first metal, likely less than 1%.

While the metallic film 103 provides electromagnetic field enhancement, a photocatalyst is required to catalyze hydrogen production using light. Referring to FIG. 1, the semiconducting photocatalyst 105 is depicted as a layer. Any known photocatalysts that are active in UV and visible range of light may be used as the photocatalyst. In one or more embodiments, the semiconducting photocatalyst 105 is selected from the group consisting of titanium oxide (TiO₂), copper oxides (Cu₂O and CuO), zinc oxide (ZnO), vanadium oxide (VO₂), cobalt oxide (Co₃O₄), ABX₃ type perovskites, metal chalcogenides (such as CdS, CdSe, ZnS) and combinations thereof. The metallic film 103 can be combined with any photocatalyst to improve its efficiency. In one or more embodiments, the photocatalyst layer may have a thickness in an amount ranging from a lower limit of any of 1, 2, 3, 4, 5, 6, 7, 8, 9, 10, 20, 30, 40, 50, 60, 70, 80, 90, and 100 nm to an upper limit of any of 200, 250, 350, 400, 450, and 500 nm, where any lower limit can be used in combination with any mathematically compatible upper limit. It will be understood, however, that other compositions, coverage of deposition, or thicknesses may be required depending on the application.

In one or more embodiments, the plasmonic substrate 100 may further comprise an inert spacer layer (not shown) between the metallic film 103 and the semiconducting photocatalyst 105. The overall performance of the plasmonic substrate 100 and the photocatalytic conversion rate of the semiconducting photocatalyst 105 may be affected by the distance of the surface providing electromagnetic field enhancement, which is the metallic film 103, to the semiconducting photocatalyst 105. The presence of the inert spacer layer may allow for precise spacing of the metallic film 103 and the semiconducting photocatalyst 105. An inert spacer layer can be used to optimize the electromagnetic field enhancement effects to improve the excitation rates in the semiconducting photocatalyst 105. The impact on excitation rates can vary based on the separation between the semiconducting photocatalyst 105 and the metallic film 103, so a spacer layer can lead to enhanced performance. In one or more embodiments, the inert spacer layer may comprise silica. The thickness of the spacer layer may be in an amount ranging from a lower limit of any of 0.5, 0.6, 0.7, 0.8, 0.9, 1, 2, 3, and 4 nm to an upper limit of any of 5, 6, 7, 8, 9, and 10 nm, where any lower limit can be used in combination with any mathematically compatible upper limit.

In one or more embodiments, the plasmonic substrate described herein may provide an improved photocatalytic conversion rate when compared to a semiconducting photocatalyst layer on a base without the metallic film 103. The electromagnetic field enhancement provided by the metallic film 103 to the semiconducting photocatalyst 105 improves the photocatalytic conversion rate through better light absorption, increased charge separation, and suppression of electrons and holes. The uniform roughness of metallic film 103 yields uniform enhancement of the electromagnetic field and improved photocatalytic conversion rate throughout the semiconducting photocatalyst 105.

### Method of Making a Plasmonic Substrate

In another aspect, embodiments disclosed herein relate to a method for producing a plasmonic substrate as described above. FIG. 2 illustrates a schematic representation of steps for fabricating a plasmonic substrate in accordance with one or more embodiments. The steps include depositing 200 a first metal layer 201 comprising a first metal on a base 203 and depositing 205 a second metal layer 207 comprising a second metal on the first metal layer 201. The second metal layer 207 has a uniform but incomplete coverage of the first metal layer 201, forming a multilayered metal template 208. After the second metal layer 207 is deposited, the multilayered metal template 208 is immersed into a solution of salt or complex of the second metal, which allows for solution deposition 209 of the second metal onto the multilayered metal template 208. The solution depositions yield a metallic film 211 that exhibits uniform nanoscale roughness. After formation of the metallic film 211, a semiconducting photocatalyst 221 can be deposited over the metallic film 211, either with 219 or without 215 an inert spacer layer 217 being deposited 213 on the metallic film 211. The method is described in greater detail as follows.

The formation of metallic film 211 requires the use of two metals. The first metal is a pure metal in its zero-oxidation state. The second metal is used as a pure metal in its zero-oxidation state for physical vapor deposition (PVD), but is also used as a soluble complex or salt in its higher oxidation state during solution deposition 209. The second metal has a reduction potential that is higher than the first metal in order for the solution deposition to take place.

In one or more embodiments, depositing a first metal layer onto a base first involves preparation of the base. Preparation of the base may include cleaning to remove organic matter, particles, or other contaminants on the surface as such contaminants can impact the adhesion of subsequent layers. The base may be prepared by cleaning with piranha solution (3:1 mixture of concentrated sulfuric acid and hydrogen peroxide) and then rinsing with purified water. The base is as previously described. After preparation of the base, which includes appropriate cleaning, the first metal layer may be deposited through PVD, which allows for deposition of specific and controlled thicknesses. In one or more embodiments, the first metal layer is deposited at a thickness in an amount ranging from a lower limit of any of 10, 11, 12, 13, 14, 15, 16, 17, 18, 19, 20, 30, 40, 50, 60, 70, 80 90, 100 nm to an upper limit of any of 110, 120, 130, 140, 150, 160, 170, 180, 190, and 200 nm, where any lower limit can be used in combination with any mathematically compatible upper limit. The thickness of the first metal layer generally determines the eventual roughness in the metallic film. For example, a thicker first metal layer results in a higher roughness as compared to a thinner first metal layer. In addition to PVD, other deposition methods such as chemical vapor deposition may be used to deposit the first metal layer onto the base.

Suitable deposition conditions for the PVD of the first metal layer may include the first metal being deposited by thermal vapor deposition at a pressure on the order of 10⁻⁶ torr. The deposition is done by heating the corresponding metal in the vacuum chamber with a deposition rate in an amount ranging from a lower limit of any of 0.5, 0.6, 0.7, 0.8, 0.9, and 1.0 Å/s to an upper limit of any of 1, 2, 3, 4, an 5 Å/s, where any lower limit can be used in combination with any mathematically compatible upper limit The deposition of the first metal layer covers the base and serves as a surface for deposition of the second metal layer. The first metal layer may be generally continuous with an RMS roughness less than 1 nm. In embodiments in which the thickness of the films is less than about 20-30 nm, complete surface coverage may not be able to be achieved. In such embodiments, particulate or island-like morphologies may be formed. A morphology having more interconnection and coverage improves with thickness and slower deposition rates. The lower reduction potential of the first metal compared to the second metal enables galvanic rearrangement of the surface during the solution deposition step, as described below.

After deposition of the first metal layer over the base through PVD, a second metal layer comprising the second metal is deposited onto the first metal layer through a similar PVD process as the first metal layer to form the multilayered metal template 208. Suitable deposition conditions that may be used for the PVD of the second metal layer include the second metal being deposited at a pressure on the order of 10⁻⁶ torr. The deposition is done by heating the corresponding pure metal in the vacuum chamber with a deposition rate in an amount ranging from a lower limit of any of 0.1, 0.2, 0.3, 0.4, and 0.5 Å/s to an upper limit of any of 0.6, 0.7, 0.8, 0.9, and 1.0 Å/s, where any lower limit can be used in combination with any mathematically compatible upper limit. Preferably the deposition rate is less than 0.5 Å/s. In one or more embodiments, the deposition of the second metal is not carried out to a degree of coverage that results in a continuous layer, as is done with the first metal layer. The total amount of the second metal deposited will affect the coverage morphology, with a continuous layer resulting if enough of the second metal were to be deposited.

During PVD of the second metal, areas of second metal deposition nucleate randomly across the surface of the sample and grow in size. As the second metal is deposited, island-like structures form. From a top view, the areas of second metal coverage resemble discrete island-like structures that are not interconnected, with portions of the first metal layer exposed and separating the areas of second metal coverage. To achieve this island-like coverage morphology, an amount of the second metal is deposited that results in a thickness of the second metal layer in an amount ranging from a lower limit of any of 1.0, 1.1, 1.2, 1.3, 1.4, 1.5, 1.6, 1.7, 1.8, 1.9, 2, and 3 nm to an upper limit of any of 4, 5, 6, 7, 8, 9, and 10 nm, where any lower limit can be used in combination with any mathematically compatible upper limit.

If more of the second metal is deposited, the areas of second metal coverage change in morphology. The amount of metal deposited determines the structures which form such as spheres or islands or interconnected structures. Initially, at low film thickness, the deposited metal will form discrete spherical structures. With increasing thickness, as more metal starts to deposit the discrete particles grow and start to fill in gaps leading to the evolution of different structures. If a sufficient amount of the second metal is deposited, the discrete island-like structures elongate and form interconnected structures, where there are still exposed portions of the first metal layer between the interconnected structures. To achieve this morphology with elongated structures, an amount of the second metal is deposited that results in a thickness of the second metal layer in the range of 5 to 10 nm. Either of these morphologies of multilayered metal template 208 may be used for the solution deposition 209, with the final morphology of the metallic film affected by the morphology of the multilayered metal template 208.

The second metal layer on the first metal layer serves as an area for nucleation of the second metal deposition during a solution deposition step. In a galvanic displacement reaction, a first metal forms a sacrificial template and when this sacrificial template is exposed to a solution of a second metal ion, the second metal ion gets deposited as a metal in place of the first metal. The first metal has a lower reduction potential compared to the second metal. When the first metal is exposed to a solution of the second metal ions, an electroless Galvanic reaction begins. During this reaction the first metal oxidizes into a soluble metal ion while the second metal ions are reduced and get deposited as metal. In the case of the current disclosure, the first metal is the sacrificial template with a lower reduction potential than the second metal which reacts and gets deposited replacing it. The deposition initiates at random spots over the surface and these random spots act as nucleation sites where further deposition occurs until the Galvanic reaction is sustained. The deposition of the second metal and dissolution of the first metal leads to the development of a rough surface. In one or more embodiments, the coverage morphology of the second metal is such that it is distributed uniformly in weight over a given surface area across the sample, and this coverage morphology yields uniform second metal deposition during a solution deposition step. A uniform deposition of the second metal and subsequent Galvanic reaction between the first metal and second metal during solution deposition allows for uniform nano-roughness of the resultant metallic film.

In the absence of the second metal layer over the first metal layer, the Galvanic reaction initiates at random locations over surface of the first metal layer and initial second metal deposition occurs at these random locations and then spreads radially from those random locations. The initial random deposition of the second metal and subsequent radial growth from random locations in this case results in a film that does not exhibit uniform nanoscale roughness. Variation in micro-level to nano-level roughness can have a significant effect on the uniformity of the plasmonic field enhancement over the area of the metallic film.

Before immersing the multilayered metal template 208 into a solution of salt or complex of the second metal, the solution of salt or complex of the second metal is prepared. This is done by mixing the second metal salt or complex in water or in an appropriate solvent with high solubility. The concentration of the second metal salt or complex may be in an amount ranging from a lower limit of any of 10⁻⁴ and 10⁻³ M to an upper limit of any of 10⁻² and 10⁻¹ M, where any lower limit can be used in combination with any mathematically compatible upper limit. The solution may be organic or aqueous. For example, if the first metal is silver, the second metal could be gold and a solution of gold complex ions can be made by dissolving chloroauric acid in water or by dissolving chloro(triphenylphosphine) gold (I) in methylene chloride, acetonitrile, benzene or acetone. Those skilled in the art will be able to suitably choose appropriate salts, complexes and solvents based on the desired metal system. As noted above and referring back to FIG. 2, in one or more embodiments, the method includes immersing the multilayered metal template 208 into a solution of salt or complex of the second metal, which allows for solution deposition 209 of the second metal onto the multilayered metal template 208. The salt or complex of the second metal is selected from the group consisting of halides, nitrates, sulfates, phosphates and organic ligands such as triphenyl phosphine and trimethylphosphine. Examples of the salt or metal complex include but are not limited to chloroauric acid salt, silver nitrate, copper sulfate, and copper nitrate. In one or more embodiments, the second metal has a reduction potential that is higher than the first metal, which causes the first metal to oxidize and get released into the solution while the second metal gets reduced and deposited in its metallic form with zero oxidation state. In one or more embodiments, the multilayered metal template 208 may be immersed in the solution of the second metal salt or complex for a period of time ranging from a lower limit of any of 1, 2, 3, 4, 5, 6, 7, 8, 9, and 10 minutes to an upper limit of any of 20, 30, 40, 50, and 60 minutes, where any lower limit can be used in combination with any mathematically compatible upper limit.

The concentration of the second metal salt or complex in solution relative to the amount of the deposited first metal layer determines the amount of reduction and deposition of the second metal in its metallic form, and the second metal replaces the first metal by oxidizing it and releasing it by dissolution. The concentration of the second metal salt or complex may be in an amount ranging from a lower limit of any of 10⁻⁴ and 10⁻³ M to an upper limit of any of 10⁻² and 10⁻¹ M, where any lower limit can be used in combination with any mathematically compatible upper limit. The surface of the multilayered metal template 208 is rearranged through the Galvanic reaction which deposits the second metal in its metallic form and releases some of the first metal into the previously described solution. The rearrangement through Galvanic reaction results in a surface that is highly nanostructured with roughness that is uniform over the metallic film surface area. Uniform nanoscale roughness enables uniform electromagnetic field enhancement across the entirety of the surface area of the metallic film. The displacement reaction proceeds to completion if the concentration and quantity of second metal ion solution is stoichiometrically in excess of the amount of first metal as thin film. After completion of the reaction, trace amounts of the first metal will still be present. When the available amount of second metal ion or complex is less than the stoichiometric amount required for the replacement of the first metal, a corresponding amount of the first metal will remain unreacted.

In one or more embodiments, after the Galvanic reaction is complete, the substrates may be cleaned with a solvent selected from the group consisting of deionized water, dilute ammonia (1% aqueous ammonia solution) followed by deionized water, methanol, ethanol, acetone, chloroform, hexane, and combinations thereof. hexane solvents to remove any residual metal salt or complex on the surface of the metallic film. The choice of solvent is dependent on the type of residue expected and their solubility. For example, the reaction of gold chloride solution with silver thin film can lead to residues of silver chloride over the nanostructured gold. AgCl can be removed with dilute ammonia followed by deionized water. When metal stearate precursors are being used, ethanol can be used for cleaning.

After formation of the metallic film via the previously described Galvanic reaction, a semiconducting photocatalyst 221 may be deposited onto the second metal. The semiconducting photocatalyst 221 may be deposited as a layer over top of the metallic film 211.

The semiconducting photocatalyst 221 may be deposited via physical vapor deposition to form a thin film or by depositing a solution of nano/submicron particles of the photocatalyst and allowing the solvent to evaporate. If deposited by physical vapor deposition technique such as thermal vapor deposition, the deposition may be done at a rate ranging from a lower limit of any of 1.0, 1.1, 1.2, 1.3, 1.4, and 1.5 Å/s to an upper limit of any of 2, 3, 4, 5, 6, 7, 8, 9, 10, 11, 12, 13, 14, and 15 Å/s, where any lower limit can be used in combination with any mathematically compatible upper limit, under a vacuum of less than 10⁻⁶ torr. Although the semiconducting photocatalyst 221 would typically be deposited through physical vapor deposition techniques, other deposition techniques may be used such as spray coating, spray pyrolysis, chemical vapor deposition, and spin coating.

In one or more embodiments, an inert spacer layer 217 may be optionally deposited over the metallic film before the semiconducting photocatalyst 221 is deposited to provide a precise spacing between the metallic film 211 and the semiconducting photocatalyst 221. In one or more embodiments, the inert spacer layer 217 comprises silica. In one or more embodiments, the inert spacer layer may be deposited through physical vapor deposition or ion beam sputtering. As is understood by those skilled in the art, other deposition techniques may be used provided they result in a uniform film being deposited. The silica spacer layer may or may not be used. When a spacer layer is used the thickness of the spacer layer can be varied from 0.5 to 10 nm. The electromagnetic field enhancement effect of a nanostructured plasmonic substrate on a photoactive material varies with the distance of separation between them. A separation of around 5 nm can increase the activity of a photocatalyst compared to direct contact. After the deposition of the inert spacer layer 217, the semiconducting photocatalyst 221 is then deposited to provide a plasmonic substrate with precise spacing between the metallic film 211 and the semiconducting photocatalyst 221.

### Method of Catalyzing Hydrogen Production

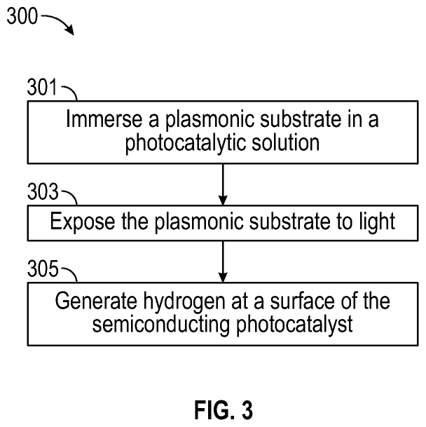

In another aspect, embodiments disclosed herein relate to a method of catalyzing hydrogen production, an example of which is shown in FIG. 3. The method of catalyzing hydrogen production 300 includes immersing a plasmonic substrate which includes a photocatalyst as is described above in a photocatalytic solution, at block 301. The photocatalytic solution may be pure water or could contain a chemical such as formic acid.

While immersed in the photocatalytic solution, the plasmonic substrate is exposed to light, at block 303, providing the conditions for photocatalytic hydrogen production. Hydrogen is then generated at the surface of the semiconducting photocatalyst, at block 305. The photocatalytic conversion is higher due to the presence of the metallic film and its uniform nanoscale roughness. The nanostructured metallic film under the photocatalyst provide electromagnetic field enhancement that increase the rate of electron hole pair generation in the photocatalyst. This increase in the rate of photoexcitation leads to a higher rate of hydrogen production.

In addition to photocatalysis, any process or method that incorporates a nanostructured metallic film with uniform nanoscale roughness such as described above may benefit from electromagnetic field enhancement. Such methods include spectroscopic techniques such as Raman or fluorescence spectroscopy which can be used for trace analyte detection in oil field production fluids.

Embodiments of the present disclosure may provide at least one of the following advantages. Uniform PVD of the second metal allows for uniform nucleation of the second metal deposition in the solution phase Galvanic reaction. Photocatalytic reactions are environmentally appealing and have a low carbon footprint, however they suffer from poor efficiency. The electromagnetic field enhancement provided by plasmonic metallic nanomaterials can improve photocatalysis through increased light absorption, increased charge separation, and suppression of electrons and holes. Providing a plasmonic surface with uniform nanoscale roughness to a photocatalyst allows for uniform enhancement of the electromagnetic field, where variation in roughness of a plasmonic substrate can lead to variations of electromagnetic field enhancement which reduces overall performance.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A plasmonic substrate comprising:
a base;
a metallic film on the base, wherein the metallic film has an RMS roughness measured by atomic force microscopy ranging from 10 to 200 nm; and
a semiconducting photocatalyst on the metallic film.

2. The plasmonic substrate of claim 1, wherein the base is selected from the group consisting of glass, quartz, silicon, doped silicon, and indium tin oxide.

3. The plasmonic substrate of claim 1, further comprising an inert spacer layer in between the metallic film and the semiconducting photocatalyst.

4. The plasmonic substrate of claim 1, wherein the semiconducting photocatalyst is selected from the group consisting of TiO₂, Cu₂O, CuO, ZnO, VO₂, Co₃O₄, ABX₃ type perovskites, CdS, CdSe, ZnS and combinations thereof.

5. The plasmonic substrate of claim 1, wherein the metallic film comprises a metal selected from the group consisting of silver, copper, gold and aluminum.

6. The plasmonic substrate of claim 1, wherein the metallic film has a thickness ranging from 10 to 500 nm.

7. The plasmonic substrate of claim 1, wherein the semiconducting photocatalyst has a thickness ranging from 1 to 500 nm.

8. The plasmonic substrate of claim 3, wherein the inert spacer layer is silica.

9. A method for producing a plasmonic substrate, the method comprising:
depositing a first metal layer having a thickness ranging from 10 to 200 nm comprising a first metal through a physical vapor deposition technique onto a base;
depositing a second metal layer comprising a second metal through a physical vapor deposition technique onto the first metal layer, thereby forming a multilayered metal template, wherein the second metal layer is deposited as a thickness ranging from 1 to 10 nm;
immersing the multilayered metal template into a solution comprising a salt or complex of the second metal for a period of time thereby forming a metallic film; and
depositing a semiconducting photocatalyst on the metallic film.

10. The method of claim 9, further comprising cleaning the metallic film with a solvent selected from the group consisting of deionized water, dilute ammonia (1% aqueous ammonia solution) followed by deionized water, methanol, ethanol, acetone, chloroform, hexane and combinations thereof before the depositing the semiconducting photocatalyst to remove any residual salt on a surface of the metallic film.

11. The method of claim 9, further comprising depositing an inert spacer layer on the metallic film before depositing the semiconducting photocatalyst.

12. The method of claim 11, wherein the inert spacer layer comprises silica.

13. The method of claim 9, wherein the immersing the multilayered metal template into a solution comprising a salt or complex of the second metal is performed for one to sixty minutes.

14. The method of claim 9, wherein a concentration of the solution comprising a salt or complex of the second metal ranges from 10⁻⁴ M to 10⁻² M.

15. The method of claim 9, wherein the first metal is selected from the group consisting of silver copper, and aluminum.

16. The method of claim 9, wherein the second metal is selected from the group consisting of gold, silver, and copper.

17. The method of claim 9, wherein the semiconducting photocatalyst is deposited through solution deposition techniques, physical vapor deposition techniques, or chemical vapor deposition techniques.

18. A method of catalyzing hydrogen production comprising:
immersing a plasmonic substrate in a photocatalytic solution, wherein the plasmonic substrate comprises:
a base,
a metallic film on the base, wherein the metallic film has an RMS roughness measured by atomic force microscopy ranging from 10 to 200 nm, and
a semiconducting photocatalyst on the metallic film,
exposing the plasmonic substrate to light; and
generating hydrogen at a surface of the semiconducting photocatalyst.

19. The method of claim 18, wherein the photocatalytic solution comprises water.

20. The method of claim 18, wherein the metallic film is selected from the group consisting of silver, copper, gold, and aluminum.

21. The method of claim 18, wherein the metallic film has a thickness ranging from 10 to 500 nm.

22. The method of claim 18, wherein the semiconducting photocatalyst is selected from the group consisting of TiO₂, Cu₂O, CuO, ZnO, VO₂, Co₃O₄, ABX₃ type perovskites, CdS, CdSe, ZnS and combinations thereof.

23. The method of claim 18, wherein the semiconducting photocatalyst has a thickness ranging from 1 to 500 nm.
